(19) United States
(12) Patent Application Publication
(10) Pub. No.: US 2021/0022528 A1
(43) Pub. Date: Jan. 28, 2021

(54) Washable Pillow

(71) Applicant: Precision Textiles LLC, Totowa, NJ (US)

(72) Inventor: Shailendra Dusaj, Montville, NJ (US)

(21) Appl. No.: 16/937,873

(22) Filed: Jul. 24, 2020

Related U.S. Application Data
(60) Provisional application No. 62/877,872, filed on Jul. 24, 2019.

(51) Int. Cl. A47G 9/10; B68G 1/00

(52) U.S. Cl. CPC A47G 9/10; B68G 2001/005; B68G 1/00

(57) ABSTRACT

A pillow includes a first panel having a first fabric layer and a second fabric layer attached to the first fabric layer and a second panel opposite the first panel and having a first fabric layer and a second fabric layer attached to the first fabric layer of the second panel, an interior portion formed between the first and second fabric layers of the first panel and the first and second fabric layers of the second panel, and a filler having a plurality of fill fibers. The density of the fill fibers is in a range of 1 denier to 15 denier, and the weight of the fibers of is in a range of 700 gsm to 1,100 gsm. The filler is foam-free.

### CROSS-REFERENCE TO RELATED APPLICATION

This application is a § 111(a) application that relates to and claims the benefit of commonly-owned, co-pending U.S. Provisional Patent Application Ser. No. 62/877,872, filed Jul. 24, 2019, entitled “WASHABLE PILLOW,” the entirety of which is incorporated herein by reference.

### FIELD OF THE INVENTION

The present invention relates to pillows and, more particularly, washable pillows that retain their mechanical properties, such as structure, shape and loft, after multiple washes and drying cycles.

### BACKGROUND OF THE INVENTION

Conventional pillows, when washed, typically lose a substantial amount of their original structure and integrity. The reason is that pillow filler material is generally not designed to be washed, as it clumps together and renders the pillow uncomfortable. What is needed is a washable pillow that maintains its structure, shape and loft after multiple washes and drying cycles.

### SUMMARY OF THE INVENTION

In an embodiment, a pillow, comprising a first panel including a first fabric layer and a second fabric layer attached to the first fabric layer; a second panel opposite the first panel, wherein the second panel includes a first fabric layer and a second fabric layer attached to the first fabric layer of the second panel; an interior portion formed by the first and second fabric layers of the first panel and the first and second fabric layers of the second panel; and a filler having a plurality of fill fibers, wherein the density of the fill fibers is in a range of 1 denier to 15 denier, and wherein the weight of the fibers of is in a range of 700 gsm to 1,100 gsm.

In an embodiment, the fill fibers are siliconized polyester fibers. In an embodiment, the fill fibers are made from 3D3V siliconized polyester fill fibers. In an embodiment, the pillow incudes a gusset intermediate the first and second panels. In an embodiment, the gusset extends around a perimeter of the pillow. In an embodiment, the gusset includes piping extending on the perimeter of the pillow.

In an embodiment, each of the first fabric layer of the first panel and the first fabric layer of the second panel includes a first microfiber fabric. In an embodiment, the first microfiber fabric includes a thread count in a range of 150 to 200. In an embodiment, the first microfiber fabric includes a weight in a range of 50 gsm to 100 gsm. In an embodiment, each of the second fabric layer of the first panel and the second fabric layer of the second panel includes a microfiber fabric having a weight in a range of 50 gsm to 100 gsm. In an embodiment, each of the first and second fabric layers of the first panel and the first and second fabric layers of the second panel are quilted. In an embodiment, each of the first and second panels includes quilted sections. In an embodiment, each of the quilted sections includes an ornamental shape. In an embodiment, each of the quilted sections includes quilting filling between the corresponding first and second fabric layers. In an embodiment, the quilting filling includes a weight in a range of 50 gsm to 100 gsm. In an embodiment, the quilting filling is made from polyester fibers. In an embodiment, the quilting filling is made from siliconized polyester fibers. In an embodiment, the filler is substantially evenly dispersed throughout the interior portion.

In an embodiment, the filler is foam-free. In an embodiment, the pillow is adapted to maintain its structure, shape and loft after being subjected to two to five washing cycles and two to five corresponding drying cycles, using a clothes washer at a wash temperature cycle in a temperature range of 80° F. to 130° F. for period in a range of 30 minutes to 40 minutes for each of the washing cycles, and using a clothes drier at a drying temperature cycle in a temperature range of 130° F. to 140° F. for a period in a range of 30 minutes to 40 minutes for each of the drying cycles.

### BRIEF DESCRIPTION OF THE DRAWINGS

FIG. 1 is a front elevational view of a pillow in accordance with an embodiment;

FIG. 2 is a side elevational view of the pillow of FIG. 1;

FIG. 3 is a close up view of quilted section of the pillow of FIG. 1;

FIG. 4 is a front elevational view of multiple fabric layers quilting filling of a cover employed by the pillow of FIG. 1; and

FIG. 5 is a front elevational view of pillow filling employed by the pillow of FIG. 1.

### DETAILED DESCRIPTION OF THE DRAWINGS

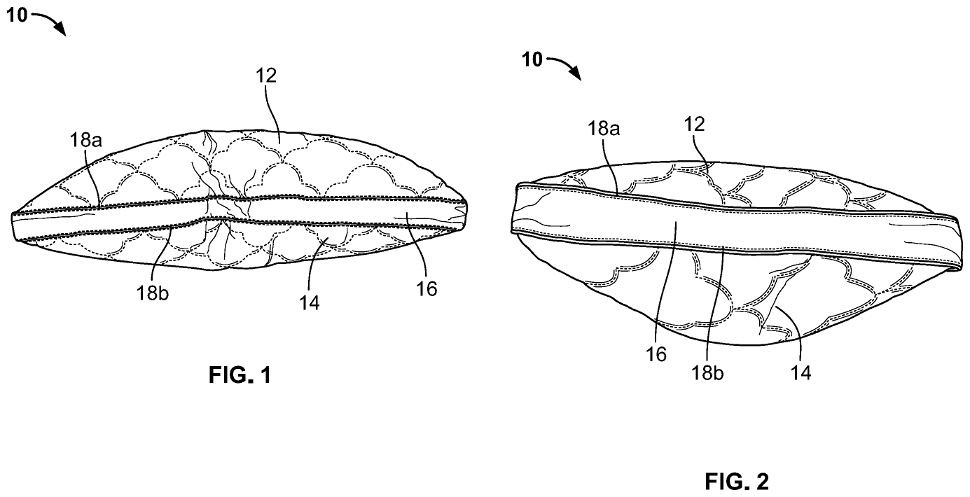

Referring to FIGS. 1 and 2, in an embodiment, a pillow 10 includes first panel 12, a second panel 14 opposite the first panel 12, and a gusset 16 intermediate the first and second panels 12, 14 and extending around a perimeter of the pillow 10. In an embodiment, the gusset includes piping 18a, 18b that extends around the perimeter of the pillow 10. In an embodiment, the first panel 12 is attached to the piping 18a and the second panel 14 is connected to the piping 18b by means known in the art, such as sewing or stitching. In another embodiment, the pillow 10 need not include the gusset 16 and the piping 18a, 18b and the first and second panels 12, 14 may be attached to one another directly.

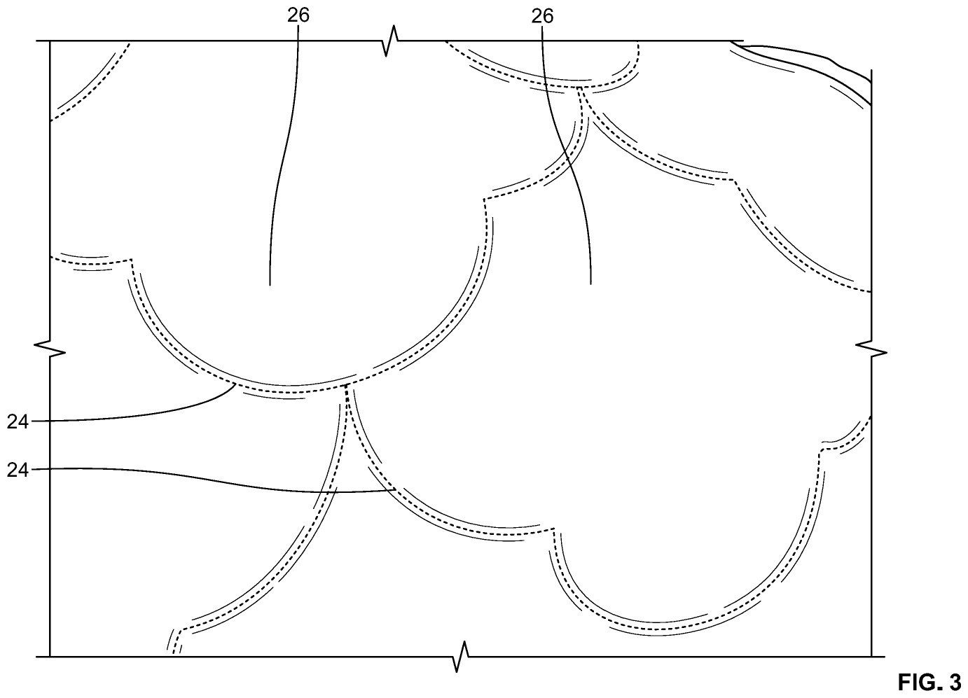

Referring to FIGS. 1 through 5, in an embodiment, each of the first and second panels 12, 14 includes a first fabric layer 20 and a second fabric layer 22 attached to the first fabric layer 20. In an embodiment, the first fabric layer 20 is a microfiber fabric. In an embodiment, the first fabric layer 20 includes a thread count in a range of 150 to 200. In another embodiment, the first fabric layer 20 includes a thread count in a range of 160 to 200. In another embodiment, the first fabric layer 20 includes a thread count in a range of 170 to 200. In another embodiment, the first fabric layer 20 includes a thread count in a range of 180 to 200. In another embodiment, the first fabric layer 20 includes a thread count in a range of 190 to 200.

In another embodiment, the first fabric layer 20 includes a thread count in a range of 150 to 190. In another embodiment, the first fabric layer 20 includes a thread count in a range of 160 to 190. In another embodiment, the first fabric layer 20 includes a thread count in a range of 170 to 190. In another embodiment, the first fabric layer 20 includes a thread count in a range of 180 to 190.

In another embodiment, the first fabric layer 20 includes a thread count in a range of 150 to 180. In another embodiment, the first fabric layer 20 includes a thread count in a range of 160 to 180. In another embodiment, the first fabric layer 20 includes a thread count in a range of 170 to 180.

In another embodiment, the first fabric layer 20 includes a thread count in a range of 150 to 170. In another embodiment, the first fabric layer 20 includes a thread count in a range of 160 to 170. In another embodiment, the first fabric layer 20 includes a thread count in a range of 150 to 160.

In an embodiment, the first fabric layer 20 includes a weight in range of 50 grams per square meter (gsm) to 100 gsm. In another embodiment, the first fabric layer 20 includes a weight in range of 55 gsm to 100 gsm. In another embodiment, the first fabric layer 20 includes a weight in range of 60 gsm to 100 gsm. In another embodiment, the first fabric layer 20 includes a weight in range of 65 gsm to 100 gsm. In another embodiment, the first fabric layer 20 includes a weight in range of 70 gsm to 100 gsm. In another embodiment, the first fabric layer 20 includes a weight in range of 75 gsm to 100 gsm. In another embodiment, the first fabric layer 20 includes a weight in range of 80 gsm to 100 gsm. In another embodiment, the first fabric layer 20 includes a weight in range of 85 gsm to 100 gsm. In another embodiment, the first fabric layer 20 includes a weight in range of 90 gsm to 100 gsm. In another embodiment, the first fabric layer 20 includes a weight in range of 95 gsm to 100 gsm.

In another embodiment, the first fabric layer 20 includes a weight in range of 50 gsm to 95 gsm. In another embodiment, the first fabric layer 20 includes a weight in range of 55 gsm to 95 gsm. In another embodiment, the first fabric layer 20 includes a weight in range of 60 gsm to 95 gsm. In another embodiment, the first fabric layer 20 includes a weight in range of 65 gsm to 95 gsm. In another embodiment, the first fabric layer 20 includes a weight in range of 70 gsm to 95 gsm. In another embodiment, the first fabric layer 20 includes a weight in range of 75 gsm to 95 gsm. In another embodiment, the first fabric layer 20 includes a weight in range of 80 gsm to 95 gsm. In another embodiment, the first fabric layer 20 includes a weight in range of 85 gsm to 95 gsm. In another embodiment, the first fabric layer 20 includes a weight in range of 90 gsm to 95 gsm.

In another embodiment, the first fabric layer 20 includes a weight in range of 50 gsm to 90 gsm. In another embodiment, the first fabric layer 20 includes a weight in range of 55 gsm to 90 gsm. In another embodiment, the first fabric layer 20 includes a weight in range of 60 gsm to 90 gsm. In another embodiment, the first fabric layer 20 includes a weight in range of 65 gsm to 90 gsm. In another embodiment, the first fabric layer 20 includes a weight in range of 70 gsm to 90 gsm. In another embodiment, the first fabric layer 20 includes a weight in range of 75 gsm to 90 gsm. In another embodiment, the first fabric layer 20 includes a weight in range of 80 gsm to 90 gsm. In another embodiment, the first fabric layer 20 includes a weight in range of 85 gsm to 90 gsm.

In another embodiment, the first fabric layer 20 includes a weight in range of 50 gsm to 85 gsm. In another embodiment, the first fabric layer 20 includes a weight in range of 55 gsm to 85 gsm. In another embodiment, the first fabric layer 20 includes a weight in range of 60 gsm to 85 gsm. In another embodiment, the first fabric layer 20 includes a weight in range of 65 gsm to 85 gsm. In another embodiment, the first fabric layer 20 includes a weight in range of 70 gsm to 85 gsm. In another embodiment, the first fabric layer 20 includes a weight in range of 75 gsm to 85 gsm. In another embodiment, the first fabric layer 20 includes a weight in range of 80 gsm to 85 gsm.

In another embodiment, the first fabric layer 20 includes a weight in range of 50 gsm to 80 gsm. In another embodiment, the first fabric layer 20 includes a weight in range of 55 gsm to 80 gsm. In another embodiment, the first fabric layer 20 includes a weight in range of 60 gsm to 80 gsm. In another embodiment, the first fabric layer 20 includes a weight in range of 65 gsm to 80 gsm. In another embodiment, the first fabric layer 20 includes a weight in range of 70 gsm to 80 gsm. In another embodiment, the first fabric layer 20 includes a weight in range of 75 gsm to 80 gsm.

In another embodiment, the first fabric layer 20 includes a weight in range of 50 gsm to 75 gsm. In another embodiment, the first fabric layer 20 includes a weight in range of 55 gsm to 75 gsm. In another embodiment, the first fabric layer 20 includes a weight in range of 60 gsm to 75 gsm. In another embodiment, the first fabric layer 20 includes a weight in range of 65 gsm to 75 gsm. In another embodiment, the first fabric layer 20 includes a weight in range of 70 gsm to 75 gsm.

In another embodiment, the first fabric layer 20 includes a weight in range of 50 gsm to 70 gsm. In another embodiment, the first fabric layer 20 includes a weight in range of 55 gsm to 70 gsm. In another embodiment, the first fabric layer 20 includes a weight in range of 60 gsm to 70 gsm. In another embodiment, the first fabric layer 20 includes a weight in range of 65 gsm to 70 gsm.

In another embodiment, the first fabric layer 20 includes a weight in range of 50 gsm to 65 gsm. In another embodiment, the first fabric layer 20 includes a weight in range of 55 gsm to 65 gsm. In another embodiment, the first fabric layer 20 includes a weight in range of 60 gsm to 65 gsm.

In another embodiment, the first fabric layer 20 includes a weight in range of 50 gsm to 60 gsm. In another embodiment, the first fabric layer 20 includes a weight in range of 55 gsm to 60 gsm. In another embodiment, the first fabric layer 20 includes a weight in range of 50 gsm to 55 gsm.

In another embodiment, the first fabric layer 20 includes a weight of 50 gsm. In another embodiment, the first fabric layer 20 includes a weight of 55 gsm. In another embodiment, the first fabric layer 20 includes a weight of 60 gsm. In another embodiment, the first fabric layer 20 includes a weight of 65 gsm. In another embodiment, the first fabric layer 20 includes a weight of 70 gsm. In another embodiment, the first fabric layer 20 includes a weight of 75 gsm. In another embodiment, the first fabric layer 20 includes a weight of 80 gsm. In another embodiment, the first fabric layer 20 includes a weight of 85 gsm. In another embodiment, the first fabric layer 20 includes a weight of 90 gsm. In another embodiment, the first fabric layer 20 includes a weight of 95 gsm. In another embodiment, the first fabric layer 20 includes a weight of 100 gsm.

In an embodiment, the second fabric layer 22 includes a weight in range of 50 grams per square meter (gsm) to 100 gsm. In another embodiment, the second fabric layer 22 includes a weight in range of 55 gsm to 100 gsm. In another embodiment, the second fabric layer 22 includes a weight in range of 60 gsm to 100 gsm. In another embodiment, the second fabric layer 22 includes a weight in range of 65 gsm to 100 gsm. In another embodiment, the second fabric layer 22 includes a weight in range of 70 gsm to 100 gsm. In another embodiment, the second fabric layer 22 includes a weight in range of 75 gsm to 100 gsm. In another embodiment, the second fabric layer 22 includes a weight in range of 80 gsm to 100 gsm. In another embodiment, the second fabric layer 22 includes a weight in range of 85 gsm to 100 gsm. In another embodiment, the second fabric layer 22 includes a weight in range of 90 gsm to 100 gsm. In another embodiment, the second fabric layer 22 includes a weight in range of 95 gsm to 100 gsm.

In another embodiment, the second fabric layer 22 includes a weight in range of 50 gsm to 95 gsm. In another embodiment, the second fabric layer 22 includes a weight in range of 55 gsm to 95 gsm. In another embodiment, the second fabric layer 22 includes a weight in range of 60 gsm to 95 gsm. In another embodiment, the second fabric layer 22 includes a weight in range of 65 gsm to 95 gsm. In another embodiment, the second fabric layer 22 includes a weight in range of 70 gsm to 95 gsm. In another embodiment, the second fabric layer 22 includes a weight in range of 75 gsm to 95 gsm. In another embodiment, the second fabric layer 22 includes a weight in range of 80 gsm to 95 gsm. In another embodiment, the second fabric layer 22 includes a weight in range of 85 gsm to 95 gsm. In another embodiment, the second fabric layer 22 includes a weight in range of 90 gsm to 95 gsm.

In another embodiment, the second fabric layer 22 includes a weight in range of 50 gsm to 90 gsm. In another embodiment, the second fabric layer 22 includes a weight in range of 55 gsm to 90 gsm. In another embodiment, the second fabric layer 22 includes a weight in range of 60 gsm to 90 gsm. In another embodiment, the second fabric layer 22 includes a weight in range of 65 gsm to 90 gsm. In another embodiment, the second fabric layer 22 includes a weight in range of 70 gsm to 90 gsm. In another embodiment, the second fabric layer 22 includes a weight in range of 75 gsm to 90 gsm. In another embodiment, the second fabric layer 22 includes a weight in range of 80 gsm to 90 gsm. In another embodiment, the second fabric layer 22 includes a weight in range of 85 gsm to 90 gsm.

In another embodiment, the second fabric layer 22 includes a weight in range of 50 gsm to 85 gsm. In another embodiment, the second fabric layer 22 includes a weight in range of 55 gsm to 85 gsm. In another embodiment, the second fabric layer 22 includes a weight in range of 60 gsm to 85 gsm. In another embodiment, the second fabric layer 22 includes a weight in range of 65 gsm to 85 gsm. In another embodiment, the second fabric layer 22 includes a weight in range of 70 gsm to 85 gsm. In another embodiment, the second fabric layer 22 includes a weight in range of 75 gsm to 85 gsm. In another embodiment, the second fabric layer 22 includes a weight in range of 80 gsm to 85 gsm.

In another embodiment, the second fabric layer 22 includes a weight in range of 50 gsm to 80 gsm. In another embodiment, the second fabric layer 22 includes a weight in range of 55 gsm to 80 gsm. In another embodiment, the second fabric layer 22 includes a weight in range of 60 gsm to 80 gsm. In another embodiment, the second fabric layer 22 includes a weight in range of 65 gsm to 80 gsm. In another embodiment, the second fabric layer 22 includes a weight in range of 70 gsm to 80 gsm. In another embodiment, the second fabric layer 22 includes a weight in range of 75 gsm to 80 gsm.

In another embodiment, the second fabric layer 22 includes a weight in range of 50 gsm to 75 gsm. In another embodiment, the second fabric layer 22 includes a weight in range of 55 gsm to 75 gsm. In another embodiment, the second fabric layer 22 includes a weight in range of 60 gsm to 75 gsm. In another embodiment, the second fabric layer 22 includes a weight in range of 65 gsm to 75 gsm. In another embodiment, the second fabric layer 22 includes a weight in range of 70 gsm to 75 gsm.

In another embodiment, the second fabric layer 22 includes a weight in range of 50 gsm to 70 gsm. In another embodiment, the second fabric layer 22 includes a weight in range of 55 gsm to 70 gsm. In another embodiment, the second fabric layer 22 includes a weight in range of 60 gsm to 70 gsm. In another embodiment, the second fabric layer 22 includes a weight in range of 65 gsm to 70 gsm.

In another embodiment, the second fabric layer 22 includes a weight in range of 50 gsm to 65 gsm. In another embodiment, the second fabric layer 22 includes a weight in range of 55 gsm to 65 gsm. In another embodiment, the second fabric layer 22 includes a weight in range of 60 gsm to 65 gsm.

In another embodiment, the second fabric layer 22 includes a weight in range of 50 gsm to 60 gsm. In another embodiment, the second fabric layer 22 includes a weight in range of 55 gsm to 60 gsm. In another embodiment, the second fabric layer 22 includes a weight in range of 50 gsm to 55 gsm.

In another embodiment, the second fabric layer 22 includes a weight of 50 gsm. In another embodiment, the second fabric layer 22 includes a weight of 55 gsm. In another embodiment, the second fabric layer 22 includes a weight of 60 gsm. In another embodiment, the second fabric layer 22 includes a weight of 65 gsm. In another embodiment, the second fabric layer 22 includes a weight of 70 gsm. In another embodiment, the second fabric layer 22 includes a weight of 75 gsm. In another embodiment, the second fabric layer 22 includes a weight of 80 gsm. In another embodiment, the second fabric layer 22 includes a weight of 85 gsm. In another embodiment, the second fabric layer 22 includes a weight of 90 gsm. In another embodiment, the second fabric layer 22 includes a weight of 95 gsm. In another embodiment, the second fabric layer 22 includes a weight of 100 gsm.

In an embodiment, the first and second fabric layers 20, 22 are quilted by stitching 24, such that each of the first and second panels 12, 14 includes quilted sections 26 having a desired ornamental shape. In an embodiment, the ornamental shape of each of the quilting sections 26 is a substantially four-leaf clover shape, each overlapping one another. In other embodiments, the quilting sections 26 may have other shapes and sizes, e.g., square, circular, triangular, rectangular, or other ornamental shape. In an embodiment, each of the quilted sections 26 includes quilting filling 28 between the first and second fabric layers 20, 22.

In an embodiment, the quilting filling 28 has a weight in a range of 50 gsm to 100 gsm. In another embodiment, the quilting filling 28 has a weight in a range of 55 gsm to 100 gsm. In another embodiment, the quilting filling 28 has a weight in a range of 60 gsm to 100 gsm. In another embodiment, the quilting filling 28 has a weight in a range of 65 gsm to 100 gsm. In another embodiment, the quilting filling 28 has a weight in a range of 70 gsm to 100 gsm. In another embodiment, the quilting filling 28 has a weight in a range of 75 gsm to 100 gsm. In another embodiment, the quilting filling 28 has a weight in a range of 80 gsm to 100 gsm. In another embodiment, the quilting filling 28 has a weight in a range of 85 gsm to 100 gsm. In another embodiment, the quilting filling 28 has a weight in a range of 90 gsm to 100 gsm. In another embodiment, the quilting filling 28 has a weight in a range of 95 gsm to 100 gsm.

In an embodiment, the quilting filling 28 has a weight in a range of 50 gsm to 95 gsm. In another embodiment, the quilting filling 28 has a weight in a range of 55 gsm to 95 gsm. In another embodiment, the quilting filling 28 has a weight in a range of 60 gsm to 95 gsm. In another embodiment, the quilting filling 28 has a weight in a range of 65 gsm to 95 gsm. In another embodiment, the quilting filling 28 has a weight in a range of 70 gsm to 95 gsm. In another embodiment, the quilting filling 28 has a weight in a range of 75 gsm to 95 gsm. In another embodiment, the quilting filling 28 has a weight in a range of 80 gsm to 95 gsm. In another embodiment, the quilting filling 28 has a weight in a range of 85 gsm to 95 gsm. In another embodiment, the quilting filling 28 has a weight in a range of 90 gsm to 95 gsm.

In an embodiment, the quilting filling 28 has a weight in a range of 50 gsm to 90 gsm. In another embodiment, the quilting filling 28 has a weight in a range of 55 gsm to 90 gsm. In another embodiment, the quilting filling 28 has a weight in a range of 60 gsm to 90 gsm. In another embodiment, the quilting filling 28 has a weight in a range of 65 gsm to 90 gsm. In another embodiment, the quilting filling 28 has a weight in a range of 70 gsm to 90 gsm. In another embodiment, the quilting filling 28 has a weight in a range of 75 gsm to 90 gsm. In another embodiment, the quilting filling 28 has a weight in a range of 80 gsm to 90 gsm. In another embodiment, the quilting filling 28 has a weight in a range of 85 gsm to 90 gsm.

In an embodiment, the quilting filling 28 has a weight in a range of 50 gsm to 85 gsm. In another embodiment, the quilting filling 28 has a weight in a range of 55 gsm to 85 gsm. In another embodiment, the quilting filling 28 has a weight in a range of 60 gsm to 85 gsm. In another embodiment, the quilting filling 28 has a weight in a range of 65 gsm to 85 gsm. In another embodiment, the quilting filling 28 has a weight in a range of 70 gsm to 85 gsm. In another embodiment, the quilting filling 28 has a weight in a range of 75 gsm to 85 gsm. In another embodiment, the quilting filling 28 has a weight in a range of 80 gsm to 85 gsm.

In an embodiment, the quilting filling 28 has a weight in a range of 50 gsm to 80 gsm. In another embodiment, the quilting filling 28 has a weight in a range of 55 gsm to 80 gsm. In another embodiment, the quilting filling 28 has a weight in a range of 60 gsm to 80 gsm. In another embodiment, the quilting filling 28 has a weight in a range of 65 gsm to 80 gsm. In another embodiment, the quilting filling 28 has a weight in a range of 70 gsm to 80 gsm. In another embodiment, the quilting filling 28 has a weight in a range of 75 gsm to 80 gsm.

In an embodiment, the quilting filling 28 has a weight in a range of 50 gsm to 75 gsm. In another embodiment, the quilting filling 28 has a weight in a range of 55 gsm to 75 gsm. In another embodiment, the quilting filling 28 has a weight in a range of 60 gsm to 75 gsm. In another embodiment, the quilting filling 28 has a weight in a range of 65 gsm to 75 gsm. In another embodiment, the quilting filling 28 has a weight in a range of 70 gsm to 75 gsm.

In an embodiment, the quilting filling 28 has a weight in a range of 50 gsm to 70 gsm. In another embodiment, the quilting filling 28 has a weight in a range of 55 gsm to 70 gsm. In another embodiment, the quilting filling 28 has a weight in a range of 60 gsm to 70 gsm. In another embodiment, the quilting filling 28 has a weight in a range of 65 gsm to 70 gsm.

In an embodiment, the quilting filling 28 has a weight in a range of 50 gsm to 65 gsm. In another embodiment, the quilting filling 28 has a weight in a range of 55 gsm to 65 gsm. In another embodiment, the quilting filling 28 has a weight in a range of 60 gsm to 65 gsm.

In an embodiment, the quilting filling 28 has a weight in a range of 50 gsm to 60 gsm. In another embodiment, the quilting filling 28 has a weight in a range of 55 gsm to 60 gsm. In another embodiment, the quilting filling 28 has a weight in a range of 50 gsm to 55 gsm.

In an embodiment, the quilting filling 28 has a weight of 50 gsm. In an embodiment, the quilting filling 28 has a weight of 55 gsm. In an embodiment, the quilting filling 28 has a weight of 60 gsm. In an embodiment, the quilting filling 28 has a weight of 65 gsm. In an embodiment, the quilting filling 28 has a weight of 70 gsm. In an embodiment, the quilting filling 28 has a weight of 75 gsm. In an embodiment, the quilting filling 28 has a weight of 80 gsm. In an embodiment, the quilting filling 28 has a weight of 85 gsm. In an embodiment, the quilting filling 28 has a weight of 90 gsm. In an embodiment, the quilting filling 28 has a weight of 95 gsm. In an embodiment, the quilting filling 28 has a weight of 100 gsm.

In an embodiment, the quilting filling 28 is made from polyester fibers. In an embodiment, the quilting filling 28 is made from siliconized polyester fibers.

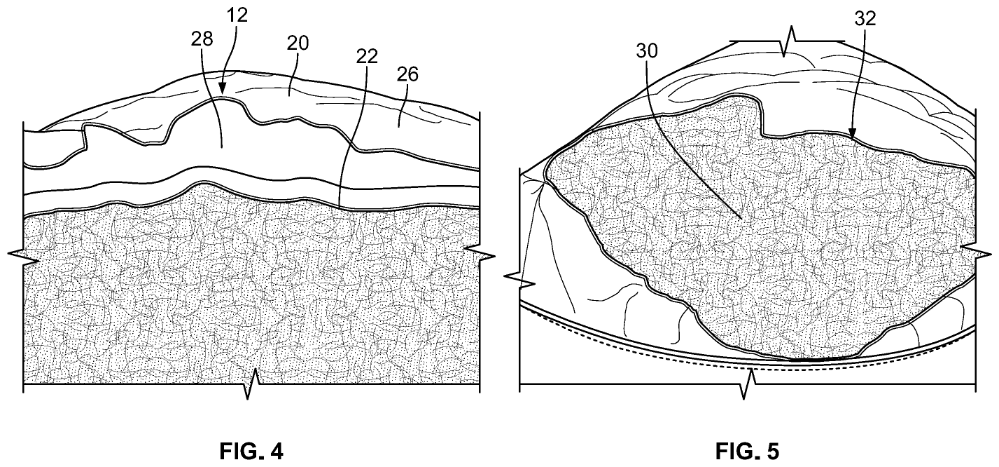

Referring to FIG. 4, the pillow 10 includes pillow filler 30 or batting that is stuffed in an interior portion 32 thereof formed by and between the first and second fabric layers 20, 22 of each of the first panel 12 and the second panel 14. In an embodiment, the filler 30 is made from siliconized polyester fibers. In an embodiment, the filler 30 is made from 3D3V siliconized polyester fill fibers. The filler 30 provides the pillow 30 with loft and helps the pillow 30 retain its shape.

In an embodiment, the density of the fibers of the filler 30 is in a range of 1 denier to 15 denier. In another embodiment, the density of the fibers of the filler 30 is in a range of 2 denier to 15 denier. In another embodiment, the density of the fibers of the filler 30 is in a range of 3 denier to 15 denier. In another embodiment, the density of the fibers of the filler 30 is in a range of 4 denier to 15 denier. In another embodiment, the density of the fibers of the filler 30 is in a range of 5 denier to 15 denier. In another embodiment, the density of the fibers of the filler 30 is in a range of 6 denier to 15 denier. In another embodiment, the density of the fibers of the filler 30 is in a range of 7 denier to 15 denier. In another embodiment, the density of the fibers of the filler 30 is in a range of 8 denier to 15 denier. In another embodiment, the density of the fibers of the filler 30 is in a range of 9 denier to 15 denier. In another embodiment, the density of the fibers of the filler 30 is in a range of 10 denier to 15 denier. In another embodiment, the density of the fibers of the filler 30 is in a range of 11 denier to 15 denier. In another embodiment, the density of the fibers of the filler 30 is in a range of 12 denier to 15 denier. In another embodiment, the density of the fibers of the filler 30 is in a range of 13 denier to 15 denier. In another embodiment, the density of the fibers of the filler 30 is in a range of 14 denier to 15 denier.

In another embodiment, the density of the fibers of the filler 30 is in a range of 1 denier to 14 denier. In another embodiment, the density of the fibers of the filler 30 is in a range of 2 denier to 14 denier. In another embodiment, the density of the fibers of the filler 30 is in a range of 3 denier to 14 denier. In another embodiment, the density of the fibers of the filler 30 is in a range of 4 denier to 14 denier. In another embodiment, the density of the fibers of the filler 30 is in a range of 5 denier to 14 denier. In another embodiment, the density of the fibers of the filler 30 is in a range of 6 denier to 14 denier. In another embodiment, the density of the fibers of the filler 30 is in a range of 7 denier to 14 denier. In another embodiment, the density of the fibers of the filler 30 is in a range of 8 denier to 14 denier. In another embodiment, the density of the fibers of the filler 30 is in a range of 9 denier to 14 denier. In another embodiment, the density of the fibers of the filler 30 is in a range of 10 denier to 14 denier. In another embodiment, the density of the fibers of the filler 30 is in a range of 11 denier to 14 denier. In another embodiment, the density of the fibers of the filler 30 is in a range of 12 denier to 14 denier. In another embodiment, the density of the fibers of the filler 30 is in a range of 13 denier to 14 denier.

In another embodiment, the density of the fibers of the filler 30 is in a range of 1 denier to 13 denier. In another embodiment, the density of the fibers of the filler 30 is in a range of 2 denier to 13 denier. In another embodiment, the density of the fibers of the filler 30 is in a range of 3 denier to 13 denier. In another embodiment, the density of the fibers of the filler 30 is in a range of 4 denier to 13 denier. In another embodiment, the density of the fibers of the filler 30 is in a range of 5 denier to 13 denier. In another embodiment, the density of the fibers of the filler 30 is in a range of 6 denier to 13 denier. In another embodiment, the density of the fibers of the filler 30 is in a range of 7 denier to 13 denier. In another embodiment, the density of the fibers of the filler 30 is in a range of 8 denier to 13 denier. In another embodiment, the density of the fibers of the filler 30 is in a range of 9 denier to 13 denier. In another embodiment, the density of the fibers of the filler 30 is in a range of 10 denier to 13 denier. In another embodiment, the density of the fibers of the filler 30 is in a range of 11 denier to 13 denier. In another embodiment, the density of the fibers of the filler 30 is in a range of 12 denier to 13 denier.

In another embodiment, the density of the fibers of the filler 30 is in a range of 1 denier to 12 denier. In another embodiment, the density of the fibers of the filler 30 is in a range of 2 denier to 12 denier. In another embodiment, the density of the fibers of the filler 30 is in a range of 3 denier to 12 denier. In another embodiment, the density of the fibers of the filler 30 is in a range of 4 denier to 12 denier. In another embodiment, the density of the fibers of the filler 30 is in a range of 5 denier to 12 denier. In another embodiment, the density of the fibers of the filler 30 is in a range of 6 denier to 12 denier. In another embodiment, the density of the fibers of the filler 30 is in a range of 7 denier to 12 denier. In another embodiment, the density of the fibers of the filler 30 is in a range of 8 denier to 12 denier. In another embodiment, the density of the fibers of the filler 30 is in a range of 9 denier to 12 denier. In another embodiment, the density of the fibers of the filler 30 is in a range of 10 denier to 12 denier. In another embodiment, the density of the fibers of the filler 30 is in a range of 11 denier to 12 denier.

In another embodiment, the density of the fibers of the filler 30 is in a range of 1 denier to 11 denier. In another embodiment, the density of the fibers of the filler 30 is in a range of 2 denier to 11 denier. In another embodiment, the density of the fibers of the filler 30 is in a range of 3 denier to 11 denier. In another embodiment, the density of the fibers of the filler 30 is in a range of 4 denier to 11 denier. In another embodiment, the density of the fibers of the filler 30 is in a range of 5 denier to 11 denier. In another embodiment, the density of the fibers of the filler 30 is in a range of 6 denier to 11 denier. In another embodiment, the density of the fibers of the filler 30 is in a range of 7 denier to 11 denier. In another embodiment, the density of the fibers of the filler 30 is in a range of 8 denier to 11 denier. In another embodiment, the density of the fibers of the filler 30 is in a range of 9 denier to 11 denier. In another embodiment, the density of the fibers of the filler 30 is in a range of 10 denier to 11 denier.

In another embodiment, the density of the fibers of the filler 30 is in a range of 1 denier to 10 denier. In another embodiment, the density of the fibers of the filler 30 is in a range of 2 denier to 10 denier. In another embodiment, the density of the fibers of the filler 30 is in a range of 3 denier to 10 denier. In another embodiment, the density of the fibers of the filler 30 is in a range of 4 denier to 10 denier. In another embodiment, the density of the fibers of the filler 30 is in a range of 5 denier to 10 denier. In another embodiment, the density of the fibers of the filler 30 is in a range of 6 denier to 10 denier. In another embodiment, the density of the fibers of the filler 30 is in a range of 7 denier to 10 denier. In another embodiment, the density of the fibers of the filler 30 is in a range of 8 denier to 10 denier. In another embodiment, the density of the fibers of the filler 30 is in a range of 9 denier to 10 denier.

In another embodiment, the density of the fibers of the filler 30 is in a range of 1 denier to 9 denier. In another embodiment, the density of the fibers of the filler 30 is in a range of 2 denier to 9 denier. In another embodiment, the density of the fibers of the filler 30 is in a range of 3 denier to 9 denier. In another embodiment, the density of the fibers of the filler 30 is in a range of 4 denier to 9 denier. In another embodiment, the density of the fibers of the filler 30 is in a range of 5 denier to 9 denier. In another embodiment, the density of the fibers of the filler 30 is in a range of 6 denier to 9 denier. In another embodiment, the density of the fibers of the filler 30 is in a range of 7 denier to 9 denier. In another embodiment, the density of the fibers of the filler 30 is in a range of 8 denier to 9 denier.

In another embodiment, the density of the fibers of the filler 30 is in a range of 1 denier to 8 denier. In another embodiment, the density of the fibers of the filler 30 is in a range of 2 denier to 8 denier. In another embodiment, the density of the fibers of the filler 30 is in a range of 3 denier to 8 denier. In another embodiment, the density of the fibers of the filler 30 is in a range of 4 denier to 8 denier. In another embodiment, the density of the fibers of the filler 30 is in a range of 5 denier to 8 denier. In another embodiment, the density of the fibers of the filler 30 is in a range of 6 denier to 8 denier. In another embodiment, the density of the fibers of the filler 30 is in a range of 7 denier to 8 denier.

In another embodiment, the density of the fibers of the filler 30 is in a range of 1 denier to 7 denier. In another embodiment, the density of the fibers of the filler 30 is in a range of 2 denier to 7 denier. In another embodiment, the density of the fibers of the filler 30 is in a range of 3 denier to 7 denier. In another embodiment, the density of the fibers of the filler 30 is in a range of 4 denier to 7 denier. In another embodiment, the density of the fibers of the filler 30 is in a range of 5 denier to 7 denier. In another embodiment, the density of the fibers of the filler 30 is in a range of 6 denier to 7 denier.

In another embodiment, the density of the fibers of the filler 30 is in a range of 1 denier to 6 denier. In another embodiment, the density of the fibers of the filler 30 is in a range of 2 denier to 6 denier. In another embodiment, the density of the fibers of the filler 30 is in a range of 3 denier to 6 denier. In another embodiment, the density of the fibers of the filler 30 is in a range of 4 denier to 6 denier. In another embodiment, the density of the fibers of the filler 30 is in a range of 5 denier to 6 denier.

In another embodiment, the density of the fibers of the filler 30 is in a range of 1 denier to 5 denier. In another embodiment, the density of the fibers of the filler 30 is in a range of 2 denier to 5 denier. In another embodiment, the density of the fibers of the filler 30 is in a range of 3 denier to 5 denier. In another embodiment, the density of the fibers of the filler 30 is in a range of 4 denier to 5 denier.

In another embodiment, the density of the fibers of the filler 30 is in a range of 1 denier to 4 denier. In another embodiment, the density of the fibers of the filler 30 is in a range of 2 denier to 4 denier. In another embodiment, the density of the fibers of the filler 30 is in a range of 3 denier to 4 denier.

In another embodiment, the density of the fibers of the filler 30 is in a range of 1 denier to 3 denier. In another embodiment, the density of the fibers of the filler 30 is in a range of 2 denier to 3 denier. In another embodiment, the density of the fibers of the filler 30 is in a range of 1 denier to 2 denier.

In an embodiment, the density of the fibers of the filler 30 is 1 denier. In an embodiment, the density of the fibers of the filler 30 is 2 denier. In an embodiment, the density of the fibers of the filler 30 is 3 denier. In an embodiment, the density of the fibers of the filler 30 is 4 denier. In an embodiment, the density of the fibers of the filler 30 is 5 denier. In an embodiment, the density of the fibers of the filler 30 is 6 denier. In an embodiment, the density of the fibers of the filler 30 is 7 denier. In an embodiment, the density of the fibers of the filler 30 is 8 denier. In an embodiment, the density of the fibers of the filler 30 is 9 denier. In an embodiment, the density of the fibers of the filler 30 is 10 denier. In an embodiment, the density of the fibers of the filler 30 is 11 denier. In an embodiment, the density of the fibers of the filler 30 is 12 denier. In an embodiment, the density of the fibers of the filler 30 is 13 denier. In an embodiment, the density of the fibers of the filler 30 is 14 denier. In an embodiment, the density of the fibers of the filler 30 is 15 denier.

In an embodiment, the weight of the fibers of the filler 30 is in a range of 700 gsm to 1,100 gsm. In an embodiment, the weight of the fibers of the filler 30 is in a range of 750 gsm to 1,100 gsm. In an embodiment, the weight of the fibers of the filler 30 is in a range of 800 gsm to 1,100 gsm. In an embodiment, the weight of the fibers of the filler 30 is in a range of 850 gsm to 1,100 gsm. In an embodiment, the weight of the fibers of the filler 30 is in a range of 900 gsm to 1,100 gsm. In an embodiment, the weight of the fibers of the filler 30 is in a range of 950 gsm to 1,100 gsm. In an embodiment, the weight of the fibers of the filler 30 is in a range of 1,000 gsm to 1,100 gsm. In an embodiment, the weight of the fibers of the filler 30 is in a range of 1,050 gsm to 1,100 gsm.

In an embodiment, the weight of the fibers of the filler 30 is in a range of 700 gsm to 1,050 gsm. In an embodiment, the weight of the fibers of the filler 30 is in a range of 750 gsm to 1,050 gsm. In an embodiment, the weight of the fibers of the filler 30 is in a range of 800 gsm to 1,050 gsm. In an embodiment, the weight of the fibers of the filler 30 is in a range of 850 gsm to 1,050 gsm. In an embodiment, the weight of the fibers of the filler 30 is in a range of 900 gsm to 1,050 gsm. In an embodiment, the weight of the fibers of the filler 30 is in a range of 950 gsm to 1,050 gsm. In an embodiment, the weight of the fibers of the filler 30 is in a range of 1,000 gsm to 1,050 gsm.

In an embodiment, the weight of the fibers of the filler 30 is in a range of 700 gsm to 1,000 gsm. In an embodiment, the weight of the fibers of the filler 30 is in a range of 750 gsm to 1,000 gsm. In an embodiment, the weight of the fibers of the filler 30 is in a range of 800 gsm to 1,000 gsm. In an embodiment, the weight of the fibers of the filler 30 is in a range of 850 gsm to 1,000 gsm. In an embodiment, the weight of the fibers of the filler 30 is in a range of 900 gsm to 1,000 gsm. In an embodiment, the weight of the fibers of the filler 30 is in a range of 950 gsm to 1,000 gsm.

In an embodiment, the weight of the fibers of the filler 30 is in a range of 700 gsm to 950 gsm. In an embodiment, the weight of the fibers of the filler 30 is in a range of 750 gsm to 950 gsm. In an embodiment, the weight of the fibers of the filler 30 is in a range of 800 gsm to 950 gsm. In an embodiment, the weight of the fibers of the filler 30 is in a range of 850 gsm to 950 gsm. In an embodiment, the weight of the fibers of the filler 30 is in a range of 900 gsm to 950 gsm.

In an embodiment, the weight of the fibers of the filler 30 is in a range of 700 gsm to 900 gsm. In an embodiment, the weight of the fibers of the filler 30 is in a range of 750 gsm to 900 gsm. In an embodiment, the weight of the fibers of the filler 30 is in a range of 800 gsm to 900 gsm. In an embodiment, the weight of the fibers of the filler 30 is in a range of 850 gsm to 900 gsm.

In an embodiment, the weight of the fibers of the filler 30 is in a range of 700 gsm to 850 gsm. In an embodiment, the weight of the fibers of the filler 30 is in a range of 750 gsm to 850 gsm. In an embodiment, the weight of the fibers of the filler 30 is in a range of 800 gsm to 850 gsm.

In an embodiment, the weight of the fibers of the filler 30 is in a range of 700 gsm to 800 gsm. In an embodiment, the weight of the fibers of the filler 30 is in a range of 750 gsm to 800 gsm. In an embodiment, the weight of the fibers of the filler 30 is in a range of 700 gsm to 750 gsm.

In another embodiment, the weight of the fibers of the filler 30 is 750 gsm. In an embodiment, the weight of the fibers of the filler 30 is 800 gsm. In another embodiment, the weight of the fibers of the filler 30 is 850 gsm. In another embodiment, the weight of the fibers of the filler 30 is 900 gsm. In another embodiment, the weight of the fibers of the filler 30 is 950 gsm. In another embodiment, the weight of the fibers of the filler 30 is 1,000 gsm. In another embodiment, the weight of the fibers of the filler 30 is 1,050 gsm. In an embodiment, the filler 30 is substantially evenly dispersed within the interior portion of the pillow 10. In an embodiment, the filler 30 does not include any foam.

In an embodiment, the pillow 10 maintains its loft (i.e., height), maintains its structure, and maintains its shape after multiple washes and drying cycles. In an embodiment, testing has resulted in the pillow 10 maintaining its structure, shape and loft after two to five washing cycles and two to five drying cycles, using a household clothes washer at warm wash temperature cycles in a range of 80° F. to 130° F.) for a period in a range of 30 minutes to 40 minutes for each washing cycle, and a household clothes drier at medium dry heat cycle in a temperature range of 130° F. to 140° F. for a period in a range of 30 minutes to 40 minutes for each drying cycle. The phrase “maintains its loft” as used herein means that the pillow 10 loses 0% to no more than 10% of its original loft. The phrase “maintains its shape” as used herein means that the each of the length, width and height of the pillow 10 change 0% to no more than 10% of its original length, width and height, respectively. The phrase “maintains its structure” as used herein means that the filler 30 of the pillow 10 remains substantially evenly dispersed throughout the interior portion of the pillow.

It should be understood that the embodiments described herein are merely exemplary and that a person skilled in the art may make many variations and modifications without departing from the spirit and scope of the invention. All such variations and modifications are intended to be included within the scope of the invention.

What is claimed is:

1. A pillow, comprising:
a first panel including a first fabric layer and a second fabric layer attached to the first fabric layer;
a second panel opposite the first panel, wherein the second panel includes a first fabric layer and a second fabric layer attached to the first fabric layer of the second panel;
an interior portion formed by the first and second fabric layers of the first panel and the first and second fabric layers of the second panel; and
a filler having a plurality of fill fibers, wherein the density of the fill fibers is in a range of 1 denier to 15 denier, and wherein the weight of the fibers of is in a range of 700 gsm to 1,100 gsm.

2. The pillow of claim 1, wherein the fill fibers are siliconized polyester fibers.

3. The pillow of claim 2, wherein the fill fibers are made from 3D3V siliconized polyester fill fibers.

4. The pillow of claim 1, further comprising a gusset intermediate the first and second panels.

5. The pillow of claim 4, wherein the gusset extends around a perimeter of the pillow.

6. The pillow of claim 5, wherein the gusset includes piping extending on the perimeter of the pillow.

7. The pillow of claim 1, wherein each of the first fabric layer of the first panel and the first fabric layer of the second panel includes a first microfiber fabric.

8. The pillow of claim 7, wherein the first microfiber fabric includes a thread count in a range of 150 to 200.

9. The pillow of claim 7, wherein the first microfiber fabric includes a weight in a range of 50 gsm to 100 gsm.

10. The pillow of claim 9, wherein each of the second fabric layer of the first panel and the second fabric layer of the second panel includes a microfiber fabric having a weight in a range of 50 gsm to 100 gsm.

11. The pillow of claim 1, wherein each of the first and second fabric layers of the first panel and the first and second fabric layers of the second panel are quilted.

12. The pillow of claim 11, wherein each of the first and second panels includes quilted sections.

13. The pillow of claim 12, wherein each of the quilted sections includes an ornamental shape.

14. The pillow of claim 12, wherein each of the quilted sections includes quilting filling between the corresponding first and second fabric layers.

15. The pillow of claim 14, wherein the quilting filling includes a weight in a range of 50 gsm to 100 gsm.

16. The pillow of claim 14, wherein the quilting filling is made from polyester fibers.

17. The pillow of claim 16, wherein the quilting filling is made from siliconized polyester fibers.

18. The pillow of claim 1, wherein the filler is substantially evenly dispersed throughout the interior portion.

19. The pillow of claim 1, wherein the filler is foam-free.

20. The pillow of claim 1, wherein the pillow is adapted to maintain its structure, shape and loft after being subjected to two to five washing cycles and two to five corresponding drying cycles, using a clothes washer at a wash temperature cycle in a temperature range of 80° F. to 130° F. for period in a range of 30 minutes to 40 minutes for each of the washing cycles, and using a clothes drier at a drying temperature cycle in a temperature range of 130° F. to 140° F. for a period in a range of 30 minutes to 40 minutes for each of the drying cycles.
